(19) United States
(12) Patent Application Publication
(10) Pub. No.: US 2014/0134349 A1
(43) Pub. Date: May 15, 2014

(54) METHOD AND COMPOSITION FOR RESTORING DAMAGED OPTICAL SUBSTRATES UTILIZING HIGH REFRACTIVE INDEX ULTRAVIOLET CURABLE COATING

(71) Applicant: Russell Anderson, Milwaukee, WI (US)

(72) Inventor: Russell Anderson, Milwaukee, WI (US)

(73) Assignee: DIC IMAGING PRODUCTS USA LLC, Oak Creek, WI (US)

(21) Appl. No.: 14/130,524

(22) PCT Filed: Jul. 13, 2012
(86) PCT No.: PCT/US2012/046668

§ 371 Date: Jan. 7, 2014

Related U.S. Application Data
(60) Provisional application No. 61/507,662, filed on Jul. 14, 2011.

(51) Int. Cl. G02B 1/10

(52) U.S. Cl. CPC G02B 1/105
USPC 427/517; 522/174; 522/181; 522/46; 522/33; 522/40; 522/64

(57) ABSTRACT

The present invention describes a method for repairing defects on a surface of an optical substrate. The method includes a step of providing a radiation curable coating and then applying the coating onto a surface of the optical substrate. The coating is then cured with a UV light source causing the refractive index of the coating to be less than ±10% of the refractive index of the substrate. The cured coating exhibits a viscosity less than about 315 CP at 25° C. The present invention also describes a novel coating composition for repairing optical substrates.

This application claims the benefit of U.S. Provisional Patent Application No. 61/507,662 filed Jul. 14, 2011, which hereby is incorporated by reference for all purposes as if fully set forth herein.

### BACKGROUND OF THE INVENTION

1. Field of the Invention

Generally, the present invention is directed to a method for restoring a damaged optical substrate and/or also for reducing or eliminating scratches therefrom. The present invention also is directed to a coating composition used for repairing a damaged optical substrate and/or reducing or eliminating scratches therefrom.

2. Description of the Related Art

Optical substrates, such as CDs and DVDs have become increasingly popular mediums for accessing media such as music, movies and video games. In fact, service providers, such as NetFlix and Blockbuster, have relied upon optical substrates for delivering media via mail directly to their customers. In more than a few instances however, customers may receive damaged and/or scratched optical substrates. The damage may cause the optical substrate to skip or be entirely unreadable by a digital disc reader. Moreover, scratched optical substrate also diminish the aesthetic appeal of the optical substrate. Since either or both aspects are significant concerns which may sway current and potential customers away, a solution to at least these problems is highly desired.

An optical read-out system is used to decode the digital information recorded on an optical substrate in the form of a spiral track. A laser beam passes through the bottom layer over the track and is reflected to contact a photodiode for producing an electrical signal. If there is a pit on the track's surface, the beam is reflected improperly, and no signal is produced. The optical reader backtracks until it is capable of reading an unaffected sequence on the track. This is referred to as skipping. In severe instances, the optical substrate may entirely become unreadable.

Conventional methods for repairing optical substrate include utilizing mechanical abrasion and polishing apparatuses. Specifically, the disc is polished with an abrasive and/or a waxy substance is applied to fill in the scratches. However, the wax-fill method is not preferred because the filler material can leave a hazy finish or can loosen with time. Accordingly, skipping of the optical substrate may return. In addition, polishing causes the surface of the optical media to become thin after continuous applications. As such, a new optical substrate will be required resulting in increased production costs.

Another method for processing the surface of an optical substrate suggests using volatile solvents. Specifically, volatile solvents cause the surface of the optical media to re-flow in order to fill the voids. However, such solvents are generally classified as environmentally unfriendly. In view of current and pending environmental legislation, these solvents are banned or unpreferred. Moreover, green technology initiatives in the U.S. and around the world have spurred a social outcry for reducing the use of non-economically friendly chemicals.

Processing time is another drawback with conventional methods. For example, polishing methods and solvent application can take a few minutes to process a single substrate. Longer processing times reduce commercial throughput. Moreover, running processing equipment for longer periods of time results in increased processing cost.

What is desired in the art is an improved method for repairing an optical substrate.

What is also desired in the art is an improved method for repairing an optical substrate.

What is also desired in the art is an environmentally-friendly method in view of green-technology initiatives for repairing a damaged optical substrate.

What is also desired in the art is a method for improving the aesthetic appearance of the optical substrate

What is further desired is a novel composition for improving readability and/or aesthetic features of the substrate.

### SUMMARY OF THE INVENTION

It has been conceived by the inventor that the method of the present invention significantly improves readability of an optical substrate, such as a CD or DVD, by an optical reader. Also conceived by the inventor is a method for reducing scratches on the surface of an optical substrate for improving its aesthetic appeal to users. Also described is a novel coating composition capable of improving readability as well as aesthetic appeal of the optical substrate. Further, there is described a system employing a machine for processing an optical substrate with the novel coating.

According to the inventor, the technique involves applying an energy curable coating composition with a refractive index closely matching the refractive index of the optical substrate. By so doing, the laser reading side of the optical substrate is repaired so as to minimize skipping. An additional benefit of the applied, cured coating is improved scratch resistance.

In a first aspect of the invention, there is disclosed a method for repairing defects on a surface of an optical substrate. A radiation curable coating exhibiting a viscosity less than about 315 cP at 25° C. is applied onto a surface of a substrate. The applied coating is cured with a UV light source. The cured coating has a refractive index within about ±10% of a refractive index of the substrate.

In a second aspect of the invention, there is disclosed a radiation curable composition for repairing defects on a surface of an optical substrate. The composition includes an aromatic or aliphatic (meth)acrylate oligomer greater than about 15 wt. %. Also included is (meth)acrylate monomer and a photoinitiator. The composition exhibits a viscosity less than about 315 cP at 25° C.

In a third aspect of the invention, there is disclosed an optical substrate repair system. The system includes an optical substrate with surface defects, a radiation curable composition, and a machine which applies the composition onto the optical substrate and subsequently cures the applied composition.

Additional features and advantages of the present invention will be set forth in the description which follows, and in part will be apparent from the description, or may be learned by practice of the invention. The advantages of the invention will be realized and attained by the structure particularly pointed out in the written description and claims hereof as well as the appended drawings.

### DETAILED DESCRIPTION OF THE INVENTION

Reference will now be made in detail to the embodiments of the present invention, and examples of which are illustrated in the accompanying drawings.

The application describes a method and composition for improving the readability of a damaged optical substrate. The method includes the steps of applying a composition according to the present invention onto a laser reading side of an optical substrate and then subjecting the applied coating to UV radiation. The objective is to closely match the refractive index level of the applied coating to that of the optical substrate. By so doing, the laser reading side of the optical substrate is planarized resulting in the reduction and/or elimination of skipping. In addition, the visual characteristics of the optical substrate exhibit significantly fewer scratches. When a disc becomes visually marred, it may lose resale value and give the perception to customers diminished quality even if it has an acceptable PI Sum 8 Average and performs well, e.g., in DVD and CD players. Thus, companies in the business of reselling or renting optical substrates consider the aesthetic characteristics of the optical substrate to be just as important as the PI Sum 8 average.

The composition, as will be described in more detail below, fills surface defects on the laser reading side of the optical substrate with a UV curable material. The composition has a refractive index comparable with the refractive index of the optical substrate. While the preferred material for an optical substrate for refractive index matching is polycarbonate, other plastic and glass substrates may also be used. In alternative embodiments, the compositions and method of the present invention can be used to repair borosilicate glass (RI=1.47); polymethyl methacrylate (PMMA, RI=1.49), polyethylene terephthalate (PET, RI=1.57-1.58), for various lens, packaging, window, and casing applications along with other applications where a substrate is coated with a UV curable coating. Typically, the optical substrates have a refractive index in the range of 1.45-1.60.

The optical substrate may include but is not limited to a CD, Super Audio CD, CD-R, CD-RW, DVD, DVD-R, DVD-RW, and DVR on the read side. The known optical and magneto-optical substrate include at least the following:

CD-DA=Compact Disk-Digital Audio

CD-ROM=Compact Disk-Read Only Memory

DVD-ROM=Digital Versatile Disk-Read Only Memory

CD-R=Compact Disk-Recordable

DVD-R=Digital Versatile Disk-Recordable

CD-RW=Compact Disk-Re-Writable

DVR=High Density Disk-Recordable

Generally, the composition according to the present invention includes at least a (meth)acrylated oligomer, a (meth)acrylated monomer, and a photoinitiator. The composition may include other additives as required for repairing an optical substrate according to the selected optical substrate as described in the present invention. For example, the composition may further include sensitizers, synergists, stabilizers and flow aids.

In a first aspect of the present invention, there is described a general formula including constituents of the composition and preferred weight percentages thereof. See Table 1.

TABLE 1

| Material | Wt % Range |
|---|---|
| Aromatic/aliphatic (meth))acrylate oligomer | 5-90% |
| Mono/multi-functional (meth)acrylate monomer | 5-90% |
| Photopolymerization initiator/sensitizer | 1-15% |
| Co-synergist | 0-20% |
| Flow additive | 0-5% |
| Stabilizers | 0-1% |

In one embodiment, the composition includes an aromatic (meth)acrylate oligomer. In another embodiment, the coating composition includes an aliphatic (meth) acrylate oligomer. The aromatic or aliphatic (meth)acrylate oligomer can be monofunctional. Alternatively, the aliphatic or aromatic (meth)acrylate oligomer can be multi-functional. The (meth)acrylateoligomer may be selected from any of the following, epoxy, aromatic and aliphatic urethanes, polyester, polyethers, melamines and combinations thereof.

In yet another embodiment, the oligomers may contain sulfur atoms, bromine atoms or combinations thereof. Sulphur or bromine atoms are selected for raising the refractive index of the organic material.

In a preferred embodiment, 0-90 wt. % of the coating composition includes one or more aromatic/aliphatic (meth)acrylate oligomers. In an exemplary embodiment, the amount of aromatic/aliphatic (meth)acrylate oligomer in the composition ranges from about 10-90 wt. %; 20-90 wt. %; 30-90 wt. %; 40-90 wt. %; 50-90 wt. %; 60-90 wt. %; 70-90 wt. %; and 80-90 wt. %. In an another exemplary embodiment, the amount of aromatic/aliphatic (meth)acrylate oligomer in the composition ranges from about 10-80 wt. %; 10-70 wt. %; 10-60 wt. %; 10-50 wt. %; 10-40 wt. %; 10-30 wt. %; and 10-20 wt.

%. In yet another exemplary embodiment, the amount of aromatic/aliphatic (meth)acrylate oligomer in the composition ranges from about 20-80%; 30-70%; and 40

In a further exemplary embodiment, the amount of aromatic/aliphatic (meth)acrylate oligomer in the composition is about 1 wt. %; 2 wt. %; 3 wt. %; 4 wt. %; 5 wt. %; 6 wt. %; 7 wt. %; 8 wt. %; 9 wt. %; 10 wt. %; 11 wt. %; 12 wt. %; 13 wt. %; 14 wt. %; 15 wt. %; 16 wt. %; 17 wt. %; 18 wt. %; 19 wt. %; 20 wt. %; 21 wt. %; 22 wt. %; 23 wt. %; 24 wt. %; 25 wt. %; 25 wt. %; 26 wt. %; 27 wt. %; 28 wt. %; 29 wt. %; 30 wt. %; 31 wt. %; 32 wt. %; 33 wt. %; 34 wt. %; 35 wt. %; 36 wt. %; 37 wt. %; 38 wt. %; 39 wt. %; 40 wt. %; 41 wt. %; 42 wt. %; 43 wt. %; 44 wt. %; 45 wt. %; 46 wt. %; 47 wt. %; 48 wt. %; 49 wt. %; 50 wt. %; 51 wt. %; 52 wt. %; 53 wt. %; 54 wt. %; 55 wt. %; 56 wt. %; 57 wt. %; 58 wt. %; 59 wt. %; 60 wt. %; 61 wt. %; 62 wt. %; 63 wt. %; 64 wt. %; 65 wt. %; 66 wt. %; 67 wt. %; 68 wt. %; 69 wt. %; 70 wt. %; 71 wt. %; 72 wt. %; 73 wt. %; 74 wt. %; 75 wt. %; 76 wt. %; 77 wt. %; 78 wt. %; 79 wt. %; 80 wt. %; 81 wt. %; 82 wt. %; 84 wt. %; 85 wt. %; 86 wt. %; 87 wt. %; 88 wt. %; 89 wt. %; 90 wt. %; 91 wt. %; 92 wt. %; 93 wt. %; 94 wt. %; and 95 wt. %.

In another embodiment, the coating composition includes a monofunctional (meth)acrylate monomer. Generally, (meth)acrylates that may used tetrahydrofurfuryl acrylate, cyclohexyl acrylate, n-hexyl acrylate, 2-ethoxyethyl acrylate, isodecyl acrylate, 2-methoxyethyl acrylate, 2-(2-ethoxyethoxy)ethyl acrylate, stearyl acrylate, lauryl acrylate, octyl acrylate, 2-phenoxyethyl acrylate, glycidyl acrylate, isobornyl acrylate, benzyl acrylate, tridecyl acrylate, caprolactone acrylate, ethoxylated nonylphenol acrylate, and polypropylene glycol acrylate and combinations thereof.

In an alternative embodiment, the monomer may be multifunctional. Preferably, the multi-functional monomer is selected from di-, tri-as well as acrylates of higher functionality. Diacrylates include but are not limited to triethylene glycol diacrylate, ethylene glycol diacrylate, 1,3-butylene glycol diacrylate, 1,4-butanediol diacrylate, diethylene glycol diacrylate, hexanediol diacrylate (HDODA), neopenyl glycol diacrylate, dipropylene glycol diacrylate (DPGDA), tripropylene glycol diacrylate, ethoxylated bisphenol A diacrylate, and propoxylated neopentyl glycol diacrylate. In an alternative embodiment, the (meth)acrylate monomer contains at least one alpha, beta-ethylenically unsaturated, radiation polymerizable group.

Higher functionality acrylates include but are not limited to pentaerythritol tetraacrylate, pentaerythritol triacrylate, trimethylolpropane triacrylate, ethoxylated trimethylolpropane triacrylate (TMPEOTA), ditrimethylolpropane tetraacrylate and ethoxylated pentaerythritol tetraacrylate.

In a preferred embodiment, 0-90 wt. % of the coating composition includes one or more (meth)acrylate monomers. In an exemplary embodiment, the amount of (meth)acrylate monomer in the composition ranges from about 10-90 wt. %; 20-90 wt. %; 30-90 wt. %; 40-90 wt. %; 50-90 wt. %; 60-90 wt. %; 70-90 wt. %; and 80-90 wt. %. In an another exemplary embodiment, the amount of one or more (meth)acrylate monomers in the composition ranges from about 10-80 wt. %; 10-70 wt. %; 10-60 wt. %; 10-50 wt. %; 10-40 wt. %; 10-30 wt. %; and 10-20 wt. %. In yet another exemplary embodiment, the amount of (meth)acrylate monomer in the composition ranges from about 20-80%; 30-70%; and 40-60%.

In a further exemplary embodiment, the amount of (meth)acrylate monomer in the composition is about 1 wt. %; 2 wt. %; 3 wt. %; 4 wt. %; 5 wt. %; 6 wt. %; 7 wt. %; 8 wt. %; 9 wt. %; 10 wt. %; 11 wt. %; 12 wt. %; 13 wt. %; 14 wt. %; 15 wt. %; 16 wt. %; 17 wt. %; 18 wt. %; 19 wt. %; 20 wt. %; 21 wt. %; 22 wt. %; 23 wt. %; 24 wt. %; 25 wt. %; 25 wt. %; 26 wt. %; 27 wt. %; 28 wt. %; 29 wt. %; 30 wt. %; 31 wt. %; 32 wt. %; 33 wt. %; 34 wt. %; 35 wt. %; 36 wt. %; 37 wt. %; 38 wt. %; 39 wt. %; 40 wt. %; 41 wt. %; 42 wt. %; 43 wt. %; 44 wt. %; 45 wt. %; 46 wt. %; 47 wt. %; 48 wt. %; 49 wt. %; 50 wt. %; 51 wt. %; 52 wt. %; 53 wt. %; 54 wt. %; 55 wt. %; 56 wt. %; 57 wt. %; 58 wt. %; 59 wt. %; 60 wt. %; 61 wt. %; 62 wt. %; 63 wt. %; 64 wt. %; 65 wt. %; 66 wt. %; 67 wt. %; 68 wt. %; 69 wt. %; 70 wt. %; 71 wt. %; 72 wt. %; 73 wt. %; 74 wt. %; 75 wt. %; 76 wt. %; 77 wt. %; 78 wt. %; 79 wt. %; 80 wt. %; 81 wt. %; 82 wt. %; 84 wt. %; 85 wt. %; 86 wt. %; 87 wt. %; 88 wt. %; 89 wt. %; 90 wt. %; 91 wt. %; 92 wt. %; 93 wt. %; 94 wt. %; and 95 wt. %.

In another embodiment, the coating composition may include substances which readily copolymerize with acrylate monomers and oligomers. For example, these substances include but are not limited to N-vinylformamide, N-vinylpyrrolidone, N-vinylcarbazole, methylolacrylamide, styrene, α-methylstyrene, vinylpyridine, vinyl ethers, triallyl isocyanurate, allyl acrylate and ether maleate esters.

In another exemplary embodiment, the coating composition of the present invention includes one or more photopolymerization initiators or sensitizers for ultraviolet curing. For example, the photopolymerization initiators, i.e., photoinitiators, may be selected from the list including but not limited to hydrogen extraction types such as benzophenone and its derivatives, benzoin, a-methylbenzoin, a-phenylbenzoin, a-allylbenzoin, a-benzylbenzoin, benzyl dimethyl ketal, benzoin methyl ether, benzoin ethyl ether, benzoin n-butyl ether; alpha cleavage types such as acetophoenone and derivatives thereof such as 2-hydroxy-2-methyl-1-phenyl-1-propan-1-one (HMPP), 1-hydroxycyclohexyl phenyl ketone (CPK), 2-methyl-1-[4-(methylthio)phenyl]-2-(4-morpholinyl)-1-propanone, 2-benzyl-2-2(dimethylamino)-1-[4-(4-morpholinyl)phenyl]-1-butanone, along with phenyl glyoxylic acid methyl ester, α-hydroxy ketones, acyl phosphine oxides and diphenyl trimethoxy benzyl phosphine oxide (TPO).

The coating composition comprising one or more photoinitiators may be present in an amount ranging from about 1-15 wt. %. In a preferred embodiment, the photoinitiator may be present in amount ranging from about 3-10%. More preferably, the photoinitiator may be present in amount ranging from about 4-9%.

In yet another embodiment, the photoinitiator is present in the coating composition in an amount of about 1 wt. %; 2 wt. %; 3 wt. %; 4 wt. %; 5 wt. %; 6 wt. %; 7 wt. %; 8 wt. %; 9 wt. %; 10 wt. %; 11 wt. %; 12 wt. %; 13 wt. %; 14 wt. % and 15 wt. %.

In yet another embodiment, the coating composition may include stabilizers. Stabilizers assist with prolonged storage of the composition. Stabilizers may be selected from the list including but not limited to phenothiozene, butylated hydroxytoluene (BHT) and its derivatives, hydroquinone and its derivatives such as 4-methoxy phenol, methylhydroquinone and N-nitrosophenylhydroxylamine.

In another, exemplary embodiment, colorants may also be present in the coating composition. Suitable colorants include, but are not limited to organic or inorganic pigments and dyes. Other organic and inorganic pigments and dyes can also be employed, as well as combinations that achieve the colors desired. The pigment may be any conventional organic or inorganic pigment such as zinc sulfide, Pigment White 6, Pigment Yellow 1, Pigment Yellow 3, Pigment Yellow 12, Pigment Yellow 13, Pigment Yellow 14, Pigment Yellow 17, Pigment Yellow 63, Pigment Yellow 65, Pigment Yellow 73, Pigment Yellow 74, Pigment Yellow 75, Pigment Yellow 83, Pigment Yellow 97, Pigment Yellow 98, Pigment Yellow 106, Pigment Yellow 114, Pigment Yellow 121, Pigment Yellow 126, Pigment Yellow 127, Pigment Yellow 136, Pigment Yellow 174, Pigment Yellow 176, Pigment Yellow 188, Pigment Orange 5, Pigment Orange 13, Pigment Orange 16, Pigment Orange 34, Pigment Red 2, Pigment Red 9, Pigment Red 14, Pigment Red 17, Pigment Red 22, Pigment Red 23, Pigment Red 37, Pigment Red 38, Pigment Red 41, Pigment Red 42, Pigment Red 57, Pigment Red 112, Pigment Red 122, Pigment Red 170, Pigment Red 210, Pigment Red 238, Pigment Blue 15, Pigment Blue 15:1, Pigment Blue 15:2, Pigment Blue 15:3, Pigment Blue 15:4, Pigment Green 7, Pigment Green 36, Pigment Violet 19, Pigment Violet 23, Pigment Black 7 and the like.

The colorant may also be selected from a dye or pigment certified for use by the Federal Food Drug and Cosmetics Act and include FD&C Red No. 3, D&C Red No. 6, D&C Red No. 7, D&C Red No. 9, D&C Red No. 19, D&C Red No. 21, D&C Red No. 22, D&C Red No. 27, D&C Red No. 28, D&C Red No. 30, D&C Red No. 33, D&C Red No. 34, D&C Red No. 36, FD&C Red No. 40, D&C Orange No. 5, FD&C Yellow No. 5, D&C Yellow No. 6, D&C Yellow No. 10, FD & C Blue No. 1, Iron Oxide Yellow, Iron Oxide Brown, Iron Oxide Red, Iron Oxide Black, Ferric Ammonium Ferrocyanide, Manganese Violet, Ultramarine Blue, Chrome Oxide Green, Hydrated Chrome Oxide Green, and Titanium Dioxide. Pigment compositions which are also useful in the energy curable inks of this invention are described in U.S. Pat. Nos. 4,946,508; 4,946,509; 5,024,894; and 5,062,894, each of which is incorporated herein by reference.

The dyes include but are not limited to azo dyes, anthraquinone dyes, xanthene dyes, azine dyes, combinations thereof and the like.

In yet another exemplary embodiment, the coating composition may include wax. The wax may be selected from the following: amide wax, erucamide wax, polypropylene wax, paraffin wax, polyethylene wax, teflon, carnuba wax and the like. In a preferred embodiment, the wax is a combination of waxes. In one embodiment the wax is a blend of amide and erucamide waxes. The wax can range between 0 to 4 wt. %. It is preferred that the wax be present in an amount from about 0 wt. % to about 2 wt. %.

In yet even another, exemplary embodiment, the coating composition includes surface-active agents. The surface active agents include anionic, cationic and nonionic agents as described in Kirk-Othmer Encyclopedia of Chemical Technology, Vol. 19, Interscience Publishers, New York, 1969, pp. 507-593, and Encyclopedia of Polymer Science and Technology, Vol. 13, Interscience Publishers, New York, 1970, pp. 477-486, both of which are incorporated herein by reference.

In yet even another, exemplary embodiment, the coating composition may include defoamers. The defoamer can be a silicone, organo-silicone, mineral oil or synthetic based defoamer such as Foam Blast UVD from Emerald Performance Materials.

Amine synergists may also be used in the coating composition. The amine synergist are present to produce an initiating radical when hydrogen abstraction photoinitiators, such as benzophenone and its derivatives, are utilized. In one embodiment, amine synergists of triethanol amine, methyldiethanol amine, ethyl-4-(dimethylamino) benzoate (EDB), and other acrylated amines may be used.

In yet even another, exemplary embodiment, the composition may include a plasticizer for providing flexibility and durability. Suitable plasticizers may be selected from the list including but not limited to polycarboxylic acid plasticizers, phthalate based plasticizers, trimetallate plasticizers, adipate-based plasticizers, sebacate-based plasticizers, sulfonamide plasticizers, benzoate plasticizers, maleate plasticizers, benzoate plasticizers, organophosphate plasticizers, epoxidized vegetable oil plasticizers, glycol/polyether plasticizers, nitrobenzene plasticizers, acetylated monoglyceride plasticizers, alkyl citrate plasticizers and combinations thereof.

In a second aspect of the present invention, there is described a method for repairing defects and/or scratches on a surface of an optical substrate. Generally the defects and scratches are located on a laser reading side of the optical substrate. The method includes a step of coating the applied substrate with the composition as discussed above. The coating composition can be applied by a procedure including but not limited to spin coating, dipping, roll-coating, screen printing, lithographic printing, gravure printing, inkjet printing, slot printing, spraying, stamping and padding.

If spin-coating is selected, the coating composition is applied in the form of a liquid ring or spiral in a chamber. The speed of rotation can range anywhere from about 1,000 to 10,000 rotations per minute. By so doing, the coating is uniformly applied over a surface of the substrate. Spin coating may last about 0.1 to 10 seconds. Excess coating is spun off the substrate.

In one embodiment, the repair process with UV curing may take less than 15 seconds. In a preferred embodiment, the repair process may be less than 10 seconds.

The optical substrate may have a coating thickness of about 0.001 to 100 microns thereon. Thicknesses more than 100 microns, in order to ensure sufficient curing through volume. As a result of contraction in the course of curing through volume. Higher coat thicknesses can also lead to deformation (dishing) of the optical substrate, with the consequence that they are no longer readable or writable, in a preferred embodied, coat thicknesses range between 5 to 30 μm. Coating thicknesses less than 5 μm may cause insufficient curing due to the oxygen-prohibiting effect. In another embodiment the coating thickness was about 5 μm; 6 μm; 7 μm; 8 μm; 9 μm; 10 μm; 11 μm; 12 μm; 13 μm; 14 μm; 15 μm; 16 μm; 17 μm; 18 μm; 19 μm; 20 μm; 21 μm; 22 μm; 23 μm; 24 μm; and 25 μm.

After application, the coating is immediately cured. Unless the coating is formulated for use with EB curing, it will contain a polymerization photo initiating system activatable by actinic radiation, such as UV radiation. Such a photoinitiator system has one or more compounds that directly furnish cations or free radicals when activated by actinic radiation. In the case of UV activation, the photoinitiator system may also include a sensitizer that extends the spectral response into the ultraviolet, visible and near infrared spectral regions. In a preferred embodiment, the coating is irradiated with UV rays at an integrated minimum dose of 200 mJ/cm (UVA+UVB) using a high-pressure mercury lamp (120 W/cm) and equipped with a focused reflector. Suitable sources of UV radiation may be unpulsed or pulsed.

According to the methods employed herein, the radiative output of the UV lamps used is variable from about 1000 to 20,000 watts, and preferably about 1600 to 2200 watts (for CD, CD-R, CD-RW, and DVD). The UV lamp used (manufacturer: Singulus; type: 200 BTZ/DF) may be a high-pressure mercury lamp with a variable output from about 1000 to 20,000 watts/hour. An alternative option is using standard mercury lamps, provided they emit a corresponding output in the curing-relevant UV range of about 250 to 400 nm, and preferably about 280 to 365 nm.

### Testing Procedures

Viscosity was measured at 25° C. utilizing a Brookfield DVII+ set up for cone and plate measurements equipped with spindle #CPE-40 and RPM range between 1 and 100 while keeping the torque value typically between 20-80%. Refractive index was measured utilizing an Atago NAR-1T refractometer at 25° C.

Coating thickness was measured by spin coating the formulation onto a substrate where the cured coating could be removed and measured. In this case, the formulation was spin coated onto the silver layer side of an L0 disc. The coating was cut with a razor blade, removed and measured with a Mitutoyo MC-L002 micrometer. Spin coating parameters, RPM and time, were varied until the desired coating thickness, e.g., between about 20-25 μm was obtained.

In addition, readability of the optical substrate was measured. Specifically, a laser reading side of a commercially produced dual layer DVD was subjected to 20 revolutions from a Taber Abraser 5155 equipped with CS-10F wheels and a weight of 250 g. The error rate of the abraded area was measured with a CATS SA300 analyzer manufactured by AudioDev. The analyzer was set up to measure PI Sum 8 Average of the disc wherein the disc was abraded between 32 mm and 42 mm from the center of the disc. The disc was spin coated with various UV coatings to obtain a coating thickness of about 20-25 μm. The coating was cured with 10 shots from an Ushio flash lamp system. The Pre and Post PI Sum 8 Average values were compared. See Table 3.

To understand the PI Sum 8 Average reading, the error correcting system of the DVD briefly will be discussed. Specifically, the error correcting system of the DVD includes two sets of parity data, the Inner Parity (PI) and Outer Parity (PO). The PI information is contained in the last 10 bytes of a row that is 182 bytes long. The PO information is contained in the last 16 rows of the ECC block that is 208 rows. The PI Sum 8 (Inner Parity Sum 8) is running 8 ECC block sum of PI errors. A row of an ECC Block that has at least 1 byte in error constitutes an error. This may give a possible PI error amount of 208 errors per block and ultimately, a maximum PI Sum 8 error of 1664. The average values will be reported.

Discs exhibit skipping errors if the PI Sum 8 Average goes over 280 and becomes completely unreadable by the CATS ST300 if greater than 1,000. According to a general DVD manufacturer's specification for PI Sum 8 Average, less than 280 is considered acceptable. For best performance, it would be advantageous to have the PI Sum 8 Average as low as possible. Preferably, lower than 200, more preferably lower than 50, even more preferably lower than 50 is desired.

Another test measuring the aesthetic aspect of the optical disc was performed. The optical disc was visually inspected for scratch resistance based on a scale from 0-5. Specifically, the disc was held perpendicular to eye level. Then, with a light source directly behind the observer, the visibility of the abraded area in the reflection was assessed.

In a preferred embodiment, the applied substrate would have a visual appearance rating of 0-3 after being repaired using the method and/or compositions of the present invention. In a more preferred embodiment, the discs would have a visual appearance rating of 0-2 after being repaired using the method and/or compositions of the present invention. Most preferably, the discs would have a visual appearance rating of 0-1 after being repaired using the method and/or compositions of the present invention. The ratings for each value are as follows:

0=no visual evidence of marring
1=minimal visual evidence of marring
2=slight visual evidence of marring 3=moderate visual evidence of marring
4=significant visual evidence of marring
5=severe visual evidence of marring

In the case of optical media repair, the method of the present invention would preferably provide discs with both an acceptable PI Sum 8 Average less than 280 and a visual rating in the 0-3 range, more preferably 0-2 range, most preferably 0-1 range. In the case of using the methods and/or compositions of the present invention to repair substrates not used for optical media, visual repair may become paramount. In another, exemplary embodiment, it would also be possible to use the methods and/or compositions of the present invention to provide optical media that have acceptable PI Sum 8 Average, but are marred visually, as these will still perform well in some secondary markets where appearance is less important than performance and/or price.

In another, preferred embodiment, the composition and method would yield a coating with a refractive index (RI) that approximates that of the RI of the substrate onto which it is printed. In a preferred embodiment, the intent is to repair the disc such that the PI Sum 8 Average is acceptable and the visual appearance rating is in the 0-3 range, more preferably in the 0-2 range. For this preferred embodiment, the RI of the composition would preferably be within ±5% of the RI of the disc material, more preferably within ±4%, most preferably within ±3%. Typically, optical media are constructed from polycarbonate with a refractive index of 1.586, thus in order to meet both an acceptable PI Sum 8 Average and have a visual appearance of 0-3, more preferably 0-2, the composition would preferably have a refractive index of about 1.50 to about 1.66 when used on polycarbonate, more preferably about 1.52 to about 1.65, most preferably about 1.54 to about 1.63. It is considered advantageous to have the refractive index of the coating composition match as closely as possible to that of the optical media substrate.

If the intent is to repair the optical media such that the PI Sum 8 Average is acceptable but the visual appearance is of no particular consequence, then a wider RI difference between composition and substrate is possible. For example a ± of 15% or higher is possible, as long as the PI Sum 8 Average is acceptable. Thus, for example, in the case of polycarbonate with an RI of 1.586, it may be possible to use a coating and method where the RI is in the range of 1.34-1.82, or even wider if PI Sum 8 Average is the primary objective.

### RESULTS AND DISCUSSION

According to the present invention, 5 examples, as shown in Table 2 below, were tested for readability and visual appearance. Each of examples 1-5 include a meth(acrylate) monomer, (meth)acrylate oligomer, and a photoinitiator.

TABLE 2

| | Acrylated | Acrylated | | | |
|---|---|---|---|---|---|
| Ex. # | Oligomer(s) | Monomer(s) | Photoinitiator | Synergist | Flow Aid |
| 1 | 20% Ebecryl 1290 | 38.5% CN 2303 | 4% CPK | 0 | 1.5% Resiflow LG- |
| | (hexafunctional | (hexafunctional | 4% HMPP | | 99 (acrylic flow aid |
| | urethane acrylate | polyester acrylate | 2% TPO | | from Estron |
| | from Cyctec | from Sartomer | | | Chemical) |
| | Industries) | USA) | | | |
| | | 19.9% HDODA | | | |
| | | 10% TMPEO3TA | | | |
| 2 | 20% Ebecryl 3708 | 20% HDODA | 3% CPK | 0 | 0 |
| | (epoxy acrylate | 26.9% TMPEO₃TA | 3% HMPP | | |
| | from Cytec | 10% PEA | 2% TPO | | |
| | Industries) | | | | |
| | 15% UVE-151 | | | | |
| | (epoxy acrylate | | | | |
| | from Sartomer | | | | |
| | USA) | | | | |
| 3 | 54.2% CN2601 | 12.2% HDODA | 4% CPK | 0 | 0.3% Tego Rad |
| | (brominated epoxy | 24.0% TMPTA | 4% HMPP | | 2200N (silicone |
| | acrylate from | | 1% TPO | | flow aid from |
| | Sartomer USA) | | | | Evonic Industries) |
| | | | | | 0.2% Resiflow L- |
| | | | | | 37 (acrylic flow aid |
| | | | | | from Estron |
| | | | | | Chemical) |
| 4 | 60% CN2601 | 8.4% HDODA | 6% HMPP | 2% EDB | 0.3% Tego Rad |
| | (brominated epoxy | 15% TMPTA | 8% BP | | 2200N (silicone |
| | acrylate from | | | | flow aid from |
| | Sartomer USA) | | | | Evonic Industries) |
| | | | | | 0.2% Resiflow L- |
| | | | | | 37 (acrylic flow aid |
| | | | | | from Estron |
| | | | | | Chemical) |
| 5 | 20% CN2262 | 75.7% DPGDA | 3% HMPP | 0 | 0.2% Tego Rad |
| | (polyester acrylate | | 1% TPO | | 2200N (silicone |
| | from Sartomer | | | | flow aid from |
| | USA) | | | | Evonic Industries) |

Other materials could be used to adjust the refractive index of energy curable formulations either in additive levels (0.1-10%) or as major components (10-90%) to bring the resulting refractive index close to the substrate being coated. Such materials include inorganic nanoparticles (zirconia, titania, antimony oxides, alumina and tin oxides), triazine based materials (meth)acrylated monomers and oligomers) or highly aromatic materials such as sucrose benzoate, styrene and the like.

TABLE 3

| | | | | | | Initial PI | Final PI | Visual |
|---|---|---|---|---|---|---|---|---|
| | | | | | Resulting | Sum 8 | Sum 8 | Appearance |
| | Visc. | | | Spin | Film | (average) | (average) | Rating |
| | (cps at | RI of | % Δ RI | Parameters | Thickness | of Disc | After | Before/After |
| Ex. # | 25° C.) | Example | * | (RPM/Sec) | (μm) | after Abraser | Repair | Repair |
| 1 | 120 | 1.482 | −6.55% | 1800/3 | 22 | Unreadable | 11 | 5/4 |
| | | | | | | (>1000) | | |
| 2 | 236 | 1.501 | −5.36% | 2000/4 | 20 | Unreadable | 12 | 5/4 |
| | | | | | | (>1000) | | |
| 3 | 278 | 1.525 | −3.85% | 2200/4 | 24 | Unreadable | 5 | 5/2 |
| | | | | | | (>1000) | | |
| 4 | 310 | 1.542 | −2.77% | 2200/4 | 24 | Unreadable | 27 | 5/1 |
| | | | | | | (>1000) | | |
| 5 | 17 | 1.456 | −8.19% | 1200/2 | 20 | Unreadable | 6 | 5/5 |
| | | | | | | (>1000) | | |

* Represents the difference in RI of the examples vs. that of polycarbonate, which is given at 1.586

As shown in Table 3, as the refractive index of the coating more closely matches the refractive index of the substrate, e.g., in this case polycarbonate, the visual rating improves. This makes the optical substrate visually more appealing. Examples 3 and 4 have a RI relativity close to the RI of polycarbonate substrate. These compositions represent an optical disc repair method in which both the Final PI Sum 8 average after repair and the visual appearance are optimized. Examples 3 and 4 are suitable for applications where good readability and visual appearance is desirable. Examples 1 and 2 exhibit an RI further from the RI of the polycarbonate substrate. As such, Examples 1 and 2 exhibit less attractive visual appearance ratings while maintaining a good Final PI Sum 8 average upon repair. Examples 1 and 2 may be more suitable for applications where good readability is a requirement but visual appearance is less important. Example 5 is more suitable for applications where good readability is a requirement but visual appearance is of little or no consequence.

Table 4, as shown below, describes conventional methods used to repair optical discs. Current commercial methods include waxing, disc buffing and solvent softening. For example, Scratch Out and PlastiX are can be used in these waxing methods. PlastiX, for example, includes medium aliphatic naphtha (CAS#64742-88-7), isoparaffinic hydrogcarbons (CAS#64742-48-9 and 64742-47-8), hydro-treated distillate (CAS#64742-46-7), and aluminum oxide (CAS#1344-28-1). In each of these methods, the product was shaken well, applied to a soft, clean cloth, and then used to polish visual scratches on a disc for up to a minute by applying firm pressure and small circular motions. Afterward, the disc was wiped clean. The method was repeated. The error rate was measured.

Regarding the method of disc buffing, DvdDrx and SkipDr Rejuvenating Fluid was lightly sprayed onto the scratched side of the disc. These products include water and isopropyl alcohol. The disc was inserted into the repair system with the play-side towards the FlexiWheel™. The Crank was turned clockwise until the disc competed two full rotations. The disc was then polished with a buffing square such as light sandpaper. The error rate was measured.

Regarding the solvent softening method, the solvent blend was mixed (15 parts methyl ethyl ketone, 38.5 parts distilled water, 44 parts ethanol and 2.5 parts isopropyl alcohol) and applied to the disc. The solvent was allowed to set for about 30 seconds and then wiped dry. The error rate was measured.

TABLE 4

| | | | | Visual |
|---|---|---|---|---|
| | | | Final PI Sum | Appearance |
| | | | (average) | Rating |
| Comparative | | Initial | After | Before/After |
| Example # | Description | PI Sum | Repair | Repair (0-5) |
| 1 | Wax: Scratch | Unreadable | Unreadable | 5/5 |
| | Out! | (>1000) | (>1000) | |
| 2 | Wax: PlastiX | Unreadable | 1056 | 5/5 |
| | | (>1000) | | |
| 3 | Disc Buffing: | Unreadable | 651 | 5/4 |
| | DvdDrx ® | (>1000) | | |
| 4 | Solvent | Unreadable | Unreadable | 5/5 |
| | Softening | (>1000) | (>1000) | |

As shown in Table 4, Comparative Ex. 1 using the waxing method resulted in an unreadable disc. In addition, the visual appearance did not improve after processing. Comparative Ex. 2 was readable but the Final PI Sum average after repair was still greater than 1,000. The visual appearance did not improve after processing. Comparative Ex. 3 exhibited a Final PI Sum average of 651. This value is indicative of frequent of skipping. The visual appearance slightly improved from 5 to 4 after processing. Comparative Ex. 4 using the solvent softening method exhibited an unreadable Final PI Sum average. The visual appearance did not improve after processing.

Table 5 as shown below describes the scratch resistance of uncoated and coated polycarbonate substrates. Testing was conducted by subjecting the laser reading side of a commercially produced dual layer DVD to the desired number of revolutions from a Taber Abraser 5155 equipped with CS-10F wheels and 250 g weight. The error rate of the abraded area was measured with a CATS SA300 analyzer manufactured by AudioDev. The CS-10F wheels were resurfaced with the ST-11 Refacing Stone according to the manufacturer's recommendations between tests. The results for the coated polycarbonate is derived from example 4 of the present invention.

TABLE 5

| | | PI Sum - |
|---|---|---|
| Total Taber | PI Sum - Uncoated | Coated |
| Revolutions | Polycarbonate | Polycarbonate |
| 0 | 2.4 | 5.4 |
| 5 | 768.5 | 12.8 |
| 10 | 916.6 | 23.9 |
| 20 | Unreadable (>1000) | 58.2 |
| 30 | Unreadable (>1000) | 116.8 |

According to Table 5, the PI Sum Average for a coated polycarbonate substrate with the composition of the present invention is significantly lower than the PI Sum Average for an uncoated polycarbonate after at least 5 Taber revolutions. These results show improved scratch resistance. Specifically, heavily damaged optical media, i.e., after 5 and 10 Taber revolutions according to Table 5, exhibits a PI Sum of less than about 25. Moreover, unreadable optical media, i.e., after 20 or 30 Taber revolutions, is repaired to a PI Sum of less than about 120.

The present invention has been described in detail, including the preferred embodiments thereof. However, it will be appreciated that those skilled in the art, upon consideration of the present disclosure, may make modifications and/or improvements on this invention that fall within the scope and spirit of the invention.

1. A method for repairing defects on a surface of an optical substrate comprising:
providing a radiation curable coating exhibiting a viscosity less than about 315 cP at 25° C.;
applying the radiation curable coating onto the surface of the optical substrate; and
curing the coating with a UV light source,
wherein the cured coating exhibits a refractive index within about ±10% of a refractive index of the optical substrate.

2. The method according to claim 1, wherein the refractive index is within about ±4% of the refractive index of the substrate.

3. The method according to claim 1, wherein the optical substrate with the cured coating thereon exhibits a digital error rate less than about 280.

4. The method according to claim 1, wherein the optical substrate with the cured coating thereon exhibits a visual scratch rating less than or equal to 2.

5. The method according to claim 4, wherein the visual scratch rating is less than or equal to 1.

6. The method according to claim 1, wherein the refractive index of the cured coating ranges between about 1.50 to 1.66.

7. The method according to claim 1, wherein the repair of defects on the optical substrate is performed in less than 15 seconds.

8. A radiation curable composition for repairing defects on a surface of an optical substrate, said composition comprising:
an aromatic or aliphatic (meth)acrylate oligomer in an amount greater than about 15 wt. %;
a (meth)acrylate monomer; and
a photoinitiator,
wherein said composition exhibits a viscosity less than about 315 cP at 25° C.

9. The composition according to claim 8, wherein said aromatic or aliphatic meth(acrylate) oligomer is selected from epoxies, urethanes, polyesters, polyethers, malamines and combinations thereof.

10. The composition according to claim 8, wherein said aromatic/aliphatic (meth)acrylate oligomer is less than about 70 wt. % of the composition.

11. The composition according to claim 8, wherein said meth(acrylate) monomer is about 20 to 80 wt. % of the composition.

12. The composition according to claim 11, wherein said meth(acrylate) monomer is less than about 40 wt. % of the composition.

13. The composition according to claim 8, wherein said (meth)acrylate monomer is multifunctional.

14. The composition according to claim 8, wherein said photoinitiator is selected from hydrogen extraction types such as benzophenone and derivatives thereof, alpha cleavage types such as acetophoenone and derivatives thereof, α-hydroxy ketones, acyl phosphine oxides, and combinations thereof.

15. The composition according to claim 8, wherein said composition is free of solvents.

16. A repaired optical substrate comprising the radiation curable composition according to claim 9.

17. The optical substrate according to claim 16, exhibiting a digital error rate less than 280.

18. The optical substrate according to claim 16, exhibiting a visual scratch rating less than about 3.

19. Use of the repaired optical substrate according to claim 16 in mailorder CD or DVD rentals, resale and personal use.

20. An optical medium repair system comprising:
an optical substrate including surface defects;
a radiation curable composition according to claim 9; and a machine which applies the composition onto the optical substrate and UV cures the applied composition.
